(19) United States
(12) Patent Application Publication
(10) Pub. No.: US 2008/0235503 A1
(43) Pub. Date: Sep. 25, 2008

(54) Event-based dynamic tunables

(76) Inventors: Chukwuma Akpuokwe, Sunnyvale, CA (US); Steven Roth, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/726,923

(22) Filed: Mar. 23, 2007

(51) Int. Cl. G06F 15/177

(52) U.S. Cl. 713/1

(57) ABSTRACT

Various approaches are disclosed for run-time update of a configurable kernel parameter that controls runtime operations of in an operating system kernel. In one approach, a first request is received to change a current value of a first configurable kernel parameter to a first new value. The first new value is not equal to the current value. The kernel continues to operate with the current value until occurrence of an un-timed event detected by the kernel. In response to occurrence of the event, the first new value is stored as the current value of the first configurable kernel parameter, and the kernel operates with the first new value as the current value. The receiving, delaying, storing, and operating are performed without rebooting the operating system.

### FIELD OF THE INVENTION

The present disclosure generally relates to updating configurable parameters that control execution of an operating system.

### BACKGROUND

The operating system (OS) kernel is the software that forms the core or heart of an OS. The kernel is loaded into main memory when a computer system is booted, and once the system is booted manages the systems resources, such as memory, processes and tasks, and storage, and input/output (I/O). The kernel also handles such issues as startup and initialization of the computer system. The managed processes may include application programs such as word processors, spreadsheets, games or web browsers, as well processes that provide functionality to other parts of the operating system, e.g., networking and file sharing functionality.

As described above, the kernel is a very important and central part of an OS. Additional software or code is written to make use of kernel-provided services, information and resources. The kernel may have configurable kernel parameters (known as “tunables”) that are usually managed manually.

The name of the host system, the current time of day, and the identification of the bootdevice may all be considered kernel parameters in the broadest sense of the term. There are many different variables, parameters and settings that affect kernel behavior and also many different mechanisms by which the kernel is managed. The term, “tunables,” however, refers to the set of parameters that historically have been compiled into the kernel image, and example tunables include “nproc,” “maxdsiz” and “semmns.” Historically, the set of tunables was defined by a file named “master,” and the per-system customized values of those tunables were stored in a file named either “system” or “dfile.” A program named “config” read those files and used the information to generate a file of C code (conf.c), which was then compiled and linked with the kernel code. This process is known as “rebuilding” the kernel. The resulting customized kernel could then be booted and used.

The approach for configuring tunables has changed substantially in recent years. For example, the metadata that used to be in each master file is now embedded in the kernel code itself. The system administration manager (SAM) program and mk_kernel and kctune commands present simpler interfaces for configuring the tunables.

For a number of years, the kernel had to be rebuilt and rebooted in order for the tunable value changes to take effect. Recently, an approach has been provided for dynamically updating tunables, which allows a system administrator to update the value of a tunable and have that new value take effect nearly immediately, without requiring the operating system to be rebuilt and without requiring the operating system to be rebooted. Static tunables are still used for parameters for which a dynamic change to the kernel is inappropriate. That is, static tunables require a rebuild and reboot of the operating system for effectuating the change.

With current approaches, a tunable may be either static or dynamic. Thus, the time at which the new value of a tunable will affect operation of the kernel is either delayed until the operating system is rebuilt and rebooted, or is nearly instantaneous relative to entry of the new value by the system administrator. Thus, the system administrator has a coarse level of control over changing the value of a particular tunable.

A method and apparatus that addresses these and other related problems may therefore be desirable.

### BRIEF DESCRIPTION OF THE DRAWINGS

FIG. 1 is a block diagram of a system for dynamically updating tunables used by an operating system in accordance with an embodiment of the invention;

FIG. 2A is a flowchart of an example process for updating event-based updating of dynamic tunables according to an embodiment of the invention;

FIG. 2B shows an example event registration table that may be used by the kernel event notification module to track which processes are to be notified for different events; and

FIG. 3 is a block diagram of an example computer system on which an embodiment of the invention may be implemented.

### DETAILED DESCRIPTION

There are certain tunables for which rebuilding and rebooting the operating system requires too much time and for which immediately affecting the kernel is undesirable. For example, a certain workload may require a high-resolution timer that is configurable with a tunable. However, the high-resolution timer may adversely affect the performance of other applications running on the system because of frequent interrupts. Thus, a system administrator may desire to have the high-resolution timer active only while the workload is underway. The administrator could monitor the system and use a static tunable to deactivate the high-resolution timer once the workload is complete. However, this requires that the administrator monitor the workload, and the system is unavailable during the rebuild-reboot process. Alternatively, the administrator could use a dynamic tunable to deactivate the high-resolution timer once the workload is complete. However, with this prior approach for dynamic tunables, the administrator would have to monitor the workload for completion and then manually change the value of the tunable at the appropriate time. In another approach for activating a dynamic tunable, the administrator may specify a time at which the new value is to be activated. However, the precise time at which the tunable is to be changed may be variable according to the workload or may require one or more prior observances to determine the correct time. The various embodiments of the present invention deal with tunables of this sort by providing a mechanism that allows the administrator to enter a new value for a tunable any time while the system is booted, but delays the kernel from recognizing and operating with the new value until the system signals that it is ready.

In one embodiment, an event reporting mechanism is used to signal when the new tunable value is to become effective. In response to a request to update a tunable value, for example, as entered by a system administrator, the tunable is placed into a wait state. Also, an update module registers with a kernel event notification module to receive an event notification for an event that is associated with the tunable. The kernel continues to operate with the current tunable value until the event notification is received. The system component on which application of the new tunable value depends, generates an event notification based on its processing status and provides that event notification to the kernel event notification module. The kernel event notification module notifies the update module of the event, and the update module then provides the new tunable value to the kernel and takes the tunable out of the wait state. While in the wait state, other update request for that tunable are denied and queries for the current value are replied to with the current tunable value.

It will be appreciated that a tunable parameter is generally a variable that controls the operation of the kernel, is defined in the kernel module metadata and set in the system files, and is stored in the kernel registry database by the kctune command. Tunable parameters are variables stored in the kernel registry database and can be changed by a system administrator. These tunable parameters generally control the allocation of caches within the kernel, limit the amount of resources available globally or to individual processes, limit the features that may be included, excluded or changed in the kernel. “Tunable” is shorthand for tunable parameter. A dynamic tunable is a tunable parameter whose value can be changed by a system administrator without requiring a reboot of the system to effect the change. A default value is the value assigned to a tunable parameter in the master file. Note that this value may be a function of the values of other tunable parameters. To change the values of static kernel parameters, the computer has to be shut down and the computer started over with new values. Persistent means that once a tunable value has been applied it stays in memory, can be reused multiple times and remains constant across reboots of the computer. In contrast, a tunable value which is not persistent reverts to a prior boot value after a reboot.

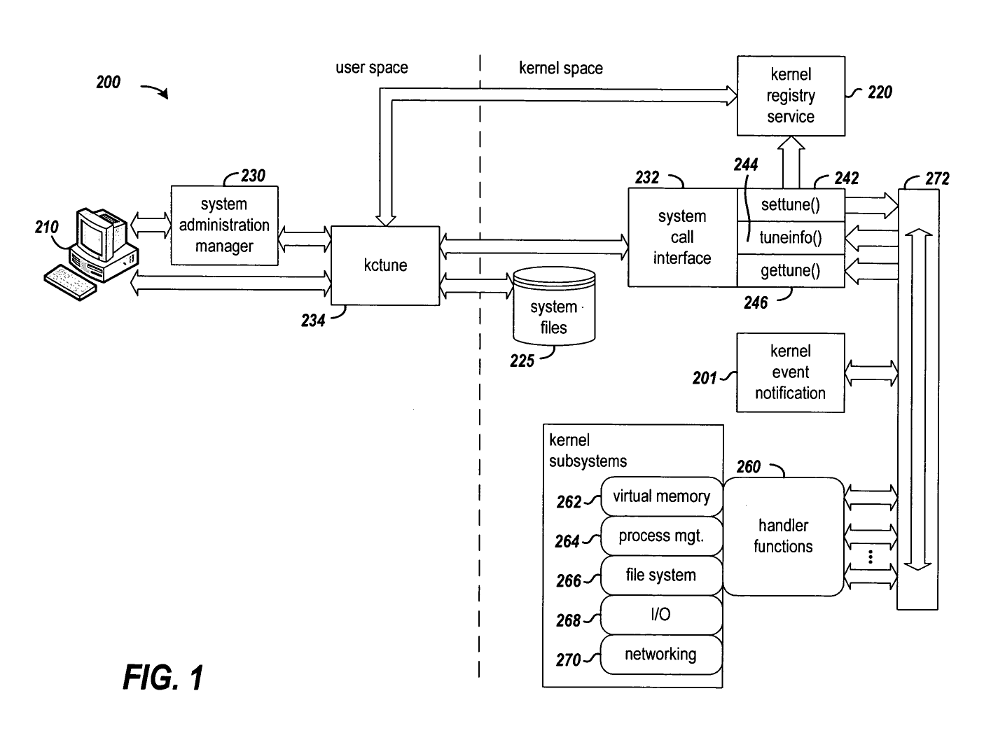

FIG. 1 is a block diagram of a system 200 for dynamically updating tunables used by an operating system in accordance with an embodiment of the invention. A kernel event notification module 201 is used in combination with the infrastructure that supports dynamic update of kernel tunables. The dynamic kernel tunables framework includes four main pieces. A data structure is maintained in the Kernel Registry Service 220 and includes information about every tunable parameter. A set of application programming interface (API) functions (settune( ) 242, tuneinfo( ) 244 and gettune( ) 246) allow commands to retrieve tunable information and change tunable settings. Handler functions 260 for each tunable are tailored to the semantics of when and how to change a tunable. The overall operation of the framework is described in the paragraphs that follow, with description of the event-based activation of tunable updates interspersed.

During normal system operation, the Kernel Registry Service 220 will include detailed information about every kernel tunable (including those which are not dynamic). The information includes its current value, its allowed range of values, a printable description, a pending value (if any), an event identifier, and so on. For event-based update of a tunable, the state of the tunable may be indicated by whether there is a pending value.

Computer 210 is used by the system administrator who can tune the OS kernel controlling the operation of system 210 directly without a reboot. The administrator can update a kernel registry service 220 and the system files 225 using the application called kctune 234, which uses the UNIX command line and provides a common user interface to the tunable parameters and the persistence mechanism. Alternatively, the administrator may use the system administration manager (SAM) 230, which is a graphical user interface. SAM 230 translates the administrator's actions into invocations of the kctune application. The kctune application can directly change the values in the kernel registry service 220 and the system files 225. It can query and change the values used by the running kernel through a system call interface 232. The system call interface 232 includes three functions: settune( ) 242, tuneinfo( ) 244 and gettune( ) 246 which will be discussed in detail below.

These functions 242, 244, 246 interface 232 with handler functions 260. There is one handler function for each dynamic tunable. Handler functions are supplied for tunables belonging to the virtual memory subsystem 262, the process management subsystem 264, the file system 266, the Input/Output subsystem 268, and the networking subsystem 270, among others. The kernel sub-system tunables can be changed through the handler functions 260 without requiring a reboot. The handler functions for accessing the tunables are described further in U.S. Pat. No. 7,143,281 to Chandramouleeswaran et al., which is incorporated herein by reference.

There are a number of different methods available for changing tunables. As described below, these methods are arranged from the most user-friendly method (SAM 230), kctune 234, to the lowest level method (kernel system calls). SAM is the System Administration Manager 230, a tool supplied with all HP-UX systems. Many system administrators have used this tool for changing tunable values. SAM handles the file changes, kernel rebuild and reboot automatically. Any time a tunable is changed using the SAM, the SAM will inform the administrator whether or not that tunable change requires a reboot. If no reboot is required, the SAM will then proceed to make the tunable change accordingly. For example, immediate update may be permissible for one tunable while update of another tunable may require the occurrence of a system event (other than reboot) prior to application and recognition of the update.

The kctune application 234 is HP-UX's supported method of changing the values of tunable parameters from the command line. The kctune application will update the proper system file 225 and kernel registry database 220 to define a new value for a specified tunable. If the specified tunable is dynamic, the kctune application will also change the value of the tunable being used by the running kernel, by calling the settune system interface function 242.

Software developers can write software that changes tunable parameters using the settune system interface function 242. Such changes will remain effective only until the system is rebooted, since settune does not modify the kernel registry database like kctune does. The gettune 246 and tuneinfo 244 functions may be used to retrieve information about tunables and their current values.

Two mechanisms are used to ensure that tunable value changes remain persistent: the system files 225 and the Kernel Registry Service (KRS) 220. These mechanisms keep tunable value changes persistent across reboots. Although the term KRS is used herein, it should be understood that any persistent parameter storage device may be used. For example, the KRS is stored in a disk file although any persistent store, such as a disk or an EEPROM can be used. The kernel parameters are persistently stored so that they can be restored after rebooting the system. The system files (or /stand/system) are an auxiliary storage mechanism that is useful because it is a text file that can be read and edited by humans.

Tunable value changes made through either SAM or kctune will remain persistent when the kernel reboots. Tunable values are stored in the KRS 220, a persistent storage mechanism. Each time the system boots, it retrieves the stored values of tunables from the KRS 220. As a result, tunable value changes will persist across reboots. (If settune 242 is used directly then the tunable value change will not be persistent.)

In one embodiment, there is a separate KRS 220 for each different kernel configuration. Tunable changes made after booting one kernel configuration will affect any future boots of that configuration, but will not affect any boots of any other configuration. As a result, tunable changes are not persistent when switching between two different kernel configurations.

Each of the dynamic tunable handler functions 260 includes the calls to the following functions: KTOP_VALIDATE, KTOP_PREPARE, and KTOP_COMMIT. KTOP_COMMIT is required; the others are optional. When the settune function 242 makes a change to a tunable value, it calls KTOP_VALIDATE to ensure that the new value is acceptable, KTOP_PREPARE to prepare for the change, and KTOP_COMMIT to finalize the change.

Kernel subsystems (virtual memory 262, process management 264, file system 266, I/O 268, networking 270, and others) are expected to register handler functions for the tunables to be made dynamic. These handler functions form the interface between the Dynamic Kernel Tunables Framework (which is a collective term for items 232, 242, 244, and 246) and the kernel subsystems. The handler functions encapsulate the knowledge of how a tunable is used by the kernel, how it can be safely changed, what values are valid and what dependencies exist between its tunable's value and range and other tunables' values.

While the system 210 is running, user space applications may access tunable information in any of several ways. The values of certain small subsets of tunables may be queried using existing pstat or sysinfo mechanisms. The value of any tunable can be queried with a call to the system function, gettune 246. The list of tunables, as well as detailed information about a tunable, can be queried with calls to the system function, tuneinfo 244.

When settune 242 is called to dynamically change the value of a tunable, it will call one of handler functions 260 for that tunable, which will have been registered by the kernel subsystem that defines that tunable. Block 272 represents calls to handler functions, as well as the data passed and returned in the calls to the handler functions. The handler functions are responsible for validating and executing tunable changes. Only tunables that have a handler function can be changed dynamically. Once a change has been validated and executed, the tunable information in the Kernel Registry Service 220 will be updated to reflect the change. At all subsequent boots, the new value of the tunable will be read from the Kernel Registry Service 220 and used in place of the value compiled into the kernel.

There are three system call interface functions that are used by SAM 230 or kctune 234 to read or change tunable values in the running kernel. The kernel contains code for the system functions gettune 246, tuneinfo 244 and settune 242.

The gettune function 246 will look up the specified tunable in the Kernel Registry. The resulting value will be returned to the caller. The gettune function 246 returns the current value of a specific tunable from the kernel. The gettune 246 function retrieves the current value of the kernel tunable parameter named tunable. The value is passed back through a supplied value pointer. The value returned is the value for the tunable that is being used by the currently running kernel. This interface may be used to obtain the values of all publicly visible tunables, regardless of whether or not they are dynamically tunable.

The settune function 242 calls the tunable handler functions for each tunable being changed, as described above. If all of these calls succeed, the new tunable values have been applied; otherwise, any incomplete changes are rolled back and appropriate errors are returned to the caller.

For certain tunables the settune function may delay activation of a new tunable value until the occurrence of certain system events. When a call is made to update one of these tunables, the settune function holds the new tunable value in abeyance and registers with the kernel event notification module 201 to be notified of the occurrence of the associated system event. The targeted one of the kernel subsystems (262, 264, 266, 268, and 270) continues to operate with the current value. In response to the targeted kernel subsystem signaling to the kernel event notification module 201 that the event has occurred, the kernel event notification module notifies the settune function. Upon receipt of the event notification, the settune function interfaces with the one of the handler functions 260 for the tunable to dynamically update the tunable value with the pending value, as described herein. Also, the settune function clears the pending value, which indicates that the tunable is no longer waiting to be changed.

In addition to the high-resolution timer discussed above, there are other tunables that may benefit from the event-driven tunable update provided by the various embodiments of the invention. For example, the tunable, nproc, controls the maximum number of processes on the system. Raising the value of nproc can be applied immediately. However, lowering that value below the current number of running processes must wait until the number of processes dropped below the desired new limit. The event reporting mechanism may be used to signal that the number of processes has dropped below the new limit. Those skilled in the art will recognize that numerous other tunables that limit resource consumption may be similarly control with the event reporting mechanism.

The tuneinfo function 244 retrieves detailed information about kernel tunable parameters. This tuneinfo 244 function provides detailed information about one or all kernel tunable parameters. When tuneinfo 244 is called to get information on all tunables, it will query the Kernel Registry Service 220 to get the complete. It will then return information on all tunables to its caller.

Different tunable parameters have different rules governing when they can be changed and what the changes mean. Here are the different possibilities: Some parameter changes require that the kernel be rebooted. For these parameters, settune 244 will hold the new value as “pending” until the system reboots. Some parameters represent limits on resources that can be consumed by individual processes. Each process has its own copy of these parameters and some of them may differ from one process to another if the setrlimit system call or an equivalent is used. For some per-process parameters, the new limits will only be enforced after a call to exec or fork.

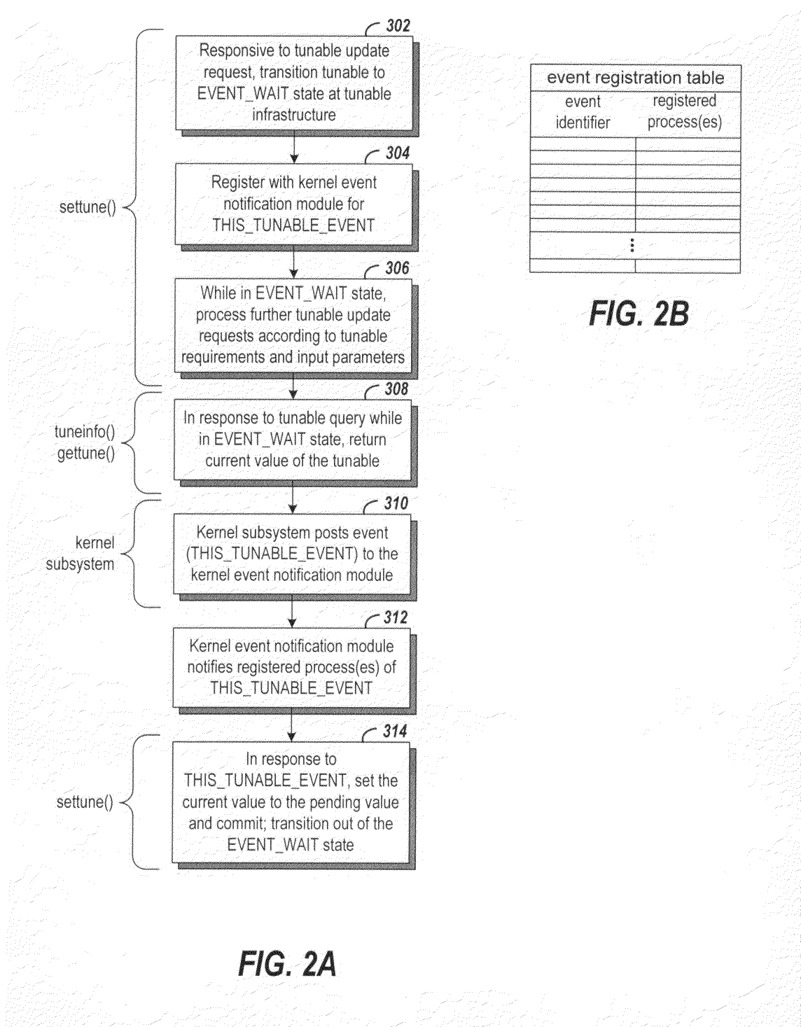

FIG. 2A is a flowchart of an example process for updating event-based updating of dynamic tunables according to an embodiment of the invention. As described above, the settune function may be used to initiate a dynamic change to a tunable. When called, the settune function checks whether the tunable referenced in the call is an event-based tunable. The value of the eventid, as described in Table 1 above, will indicate whether there is an associated event. For an event-based dynamic tunable, the settune function writes the input new value to the pending field, which is described in Table 1 of this document. The value in the pending field indicates that the tunable is in an EVENT_WAIT state as shown in step 302. At step 304 the settune function registers with the kernel event notification module 201 to be notified of the event specified by the eventid field (Table 1). FIG. 2B shows an example event registration table that may be used by the kernel event notification module 201 to track which processes are to be notified for different events.

While a tunable is in the EVENT_WAIT state, further invocations of the settune function to update the tunable may be acted upon in accordance with the requirements of the tunable or input parameters as shown by step 306. For example, for some tunables it may be desirable to reject any attempts to update the tunable while the tunable is in the EVENT_WAIT state. For other tunables, it may be acceptable to override the pending tunable value with a new value. Also, the settune function may provide an option for canceling a pending update to a tunable.

The tuneinfo and gettune functions, which retrieve information about tunables as described above, may be configured to return the current value when called as shown by step 308. In another embodiment, each function may return a list of all tunables in the EVENT_WAIT state in response to an input parameter to the function.

The kernel continues to operate with the current value of the tunable until the occurrence of the designated event. At some time during kernel runtime, a kernel subsystem is expected to report the occurrence of THIS_TUNABLE_EVENT which will trigger the dynamic update of the tunable. When the event occurs, at step 310 the kernel subsystem posts the event notification to the kernel event notification module 201. When the kernel event notification module receives such notification, it determines the process(es) that have registered to receive notification from the table FIG. 2B and sends an event notification to that process, as shown by step 312.

In response to the notification of THIS_TUNABLE_EVENT, the settune function at step 314 sets the current tunable value to the pending value and commits the value to persistent storage as described above. In addition, the pending value is cleared in order to transition the tunable out of the EVENT_WAIT state.

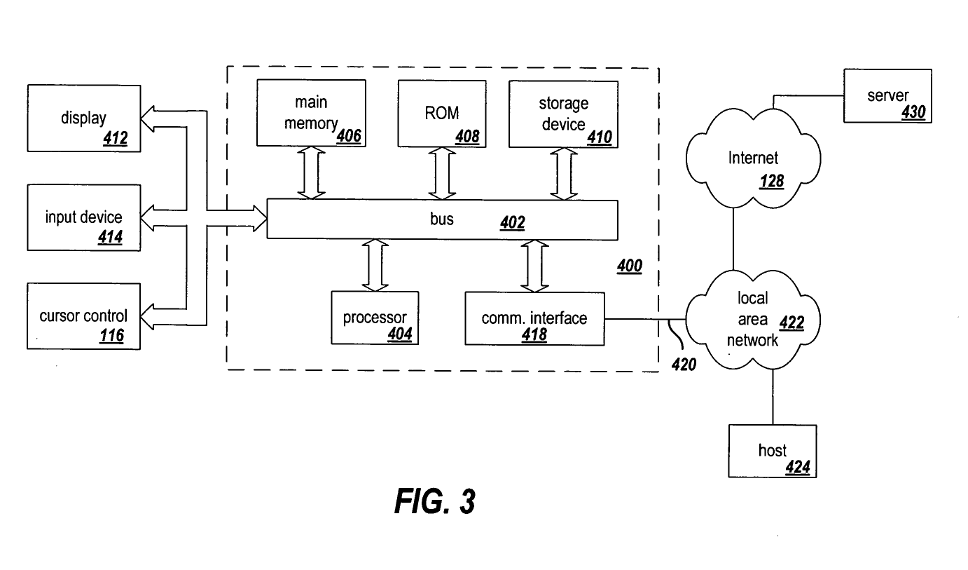

FIG. 3 is a block diagram of an example computer system 400 on which an embodiment of the invention may be implemented. The present invention is usable with currently available personal computers, mini-mainframes and the like.

Computer system 400 includes a bus 402 or other communication mechanism for communicating information, and a processor 404 coupled to the bus 102 for processing information. Computer system 400 also includes a main memory 406, such as a random access memory (RAM) or other dynamic storage device, coupled to the bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to the bus 402 for storing static information and instructions for the processor 404. A storage device 410, such as a magnetic disk or optical disk, is provided and coupled to the bus 402 for storing information and instructions.

Computer system 400 may be coupled via the bus 402 to a display 412, such as a cathode ray tube (CRT) or a flat panel display, for displaying information to a computer user. An input device 414, including alphanumeric and other keys, is coupled to the bus 402 for communicating information and command selections to the processor 404. Another type of user input device is cursor control 416, such as a mouse, a trackball, or cursor direction keys for communicating direction information and command selections to processor 404 and for controlling cursor movement on the display 412.

The embodiments of the invention are related to dynamically updating tunables for kernel subsystems that control operation of the computer system 400. A system administration manager graphical user interface is provided by computer system 400 in response to processor 404 executing sequences of instructions contained in main memory 406. Such instructions may be read into main memory 406 from another computer-readable medium, such as storage device 410. However, the computer-readable medium is not limited to devices such as storage device 410. For example, the computer-readable medium may include a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave embodied in an electrical, electromagnetic, infrared, or optical signal, or any other medium from which a computer can read. Execution of the sequences of instructions contained in the main memory 406 causes the processor 404 to perform the process steps described herein. In alternative embodiments, hard-wired circuitry may be used in combination with computer software instructions to implement the embodiments of the invention.

Computer system 400 also includes a communication interface 418 coupled to the bus 402. Communication interface 408 provides a two-way data communication as is known. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals which carry digital data streams representing various types of information. Of particular note, the communications through interface 418 may permit transmission or receipt of the dynamic tunable settings. For example, two or more computer systems 400 may be networked together in a conventional manner with each using the communication interface 418.

Network link 420 typically provides data communication through one or more networks to other data devices. For example, network link 420 may provide a connection through local network 422 to a host computer 424 or via the Internet 428. Local network 422 and Internet 428 both use electrical, electromagnetic or optical signals which carry digital data streams. The signals through the various networks and the signals on network link 420 and through communication interface 418, which carry the digital data to and from computer system 400, are exemplary forms of carrier waves transporting the information.

Computer system 400 can send data and receive data, including program code, through the network(s), network link 420 and communication interface 418. In the Internet example, a server 430 might transmit a requested code for an application program through Internet 428, local network 122 and communication interface 118.

The received code may be executed by processor 404 as it is received, and/or stored in storage device 410, or other non-volatile storage for later execution. In this manner, computer system 400 may obtain application code in the form of a carrier wave.

What is claimed is:

1. A processor-implemented method for run-time update of a configurable kernel parameter that controls runtime operations of an operating system kernel, comprising:
receiving a first request to change a current value of a first configurable kernel parameter to a first new value, wherein the first new value is not equal to the current value;
continuing operation of the kernel with the current value until occurrence of an un-timed event detected by the kernel;
storing the first new value as the current value of the first configurable kernel parameter in response to occurrence of the event;
operating the kernel with the first new value as the current value; and
wherein the receiving, delaying, storing, and operating are performed without rebooting the operating system.

2. The method of claim 1, further comprising:
assigning a first state to the first configurable kernel parameter before receiving the first request to change the current value;
assigning a second state to the first configurable kernel parameter after receiving the first request to change the current value and until the occurrence of the event; and
in response to receiving a second request to change the current value of the first configurable kernel parameter while assigned the second state, returning a code that indicates that requested change to the second new value was rejected.

3. The method of claim 1, further comprising:
assigning a first state to the first configurable kernel parameter before receiving the first request to change the current value;
assigning a second state to the first configurable kernel parameter after receiving the first request to change the current value and until the occurrence of the event; and
in response to receiving a second request to change the current value to a second new value while the first configurable kernel parameter is assigned the second state, discarding the first new value and using the second new value to update the current value.

4. The method of claim 1, further comprising:
assigning a first state to the first configurable kernel parameter before receiving the first request to change the current value;
assigning a second state to the first configurable kernel parameter after receiving the first request to change the current value and until the occurrence of the event; and
in response to receiving a cancel request for the first configurable kernel parameter while the first configurable kernel parameter is assigned the second state, discarding the first new value, continuing operation of the kernel with the current value, and assigning the first state to the first configurable kernel parameter.

5. The method of claim 1, further comprising:
assigning a first state to the first configurable kernel parameter before receiving the first request to change the current value;
assigning a second state to the first configurable kernel parameter after receiving the first request to change the current value and until the occurrence of the event; and
in response to receiving a list-pending request, outputting data indicative of each configurable parameter assigned the second state.

6. The method of claim 1, wherein the receiving, delaying, storing, and operating are performed automatically with no user interaction with the operating system kernel to control the delaying, storing, and operating subsequent to the first request.

7. A processor-implemented method for updating a tunable used in an operating system kernel, comprising:
receiving at a first module of the operating system a request to change a current value of a first tunable to a new value, wherein the value of the tunable affects execution of a second module of the operating system, and the new value is not equal to the current value;
registering, in response to the request to change the current value of the first tunable, the first module with an event notification module to receive notification of a first event associated with the first tunable;
delaying the second module from operating with the new value, and continuing to operate the second module with the current value until a notification of the first event indicates acceptability for the second module to execute with the new value;
receiving notification of the first event from a module of the operating system by the event notification module;
sending an event notification from the event notification module to the first module in response to the notification of the first event;
inputting the new value to the second module in response to receipt of the notification of the first event;
executing the second module with the new value; and
storing the new value for the first tunable in persistent storage.

8. The method of claim 7, further comprising:
transitioning the first tunable from a first state to a second state in response to the request to change the current value of the first tunable to the new value; and
in response to a request for obtaining the value of the first tunable received by the first module while in the second state, returning the current tunable value.

9. The method of claim 8, further comprising:
in response to the signal indicating acceptability for the second module to execute with the new value,
transitioning the first tunable from the second state to the first state, and
saving the new tunable value as the current tunable value; and
in response to a request for obtaining the value of the tunable received by the first module while the first tunable is in the first state, returning the current tunable value.

10. The method of claim 8, further comprising, in response to receiving a second request to change the current value of the first tunable while the first tunable is in the second state, returning a code that indicates that requested change to the second new value was rejected.

11. The method of claim 8, further comprising, in response to receiving a second request to change the current value to a second new value while the first tunable is in the second state, discarding the first new value and using the second new value to update the current value.

12. The method of claim 8, further comprising, in response to receiving a cancel request for the first tunable while the first tunable is in the second state, discarding the first new value and transitioning the first tunable to the first state.

13. The method of claim 7, wherein the registering, delaying, inputting, and executing are performed automatically with no user interaction with the operating system kernel subsequent to the first request to control the registering, delaying, inputting, and executing.

14. An apparatus for run-time update of a configurable kernel parameter used in an operating system kernel, comprising:
means for receiving a first request to change a current value of a first configurable kernel parameter to a first new value, wherein the first new value is not equal to the current value;
means for continuing operation of the module with the current value until occurrence of an un-timed event detected by the kernel;
means for storing the first new value as the current value of the first configurable kernel parameter in response to occurrence of the event;
means for operating the module with the first new value as the current value; and
wherein the receiving, delaying, storing, and operating are performed without rebooting the operating system.

15. A system for run-time update of a configurable kernel parameter used in an operating system kernel, comprising:
a first module configured to receive a request to change a current value of a first tunable to a new value, wherein the value of the tunable affects execution of a second module of the operating system, and the new value is not equal to the current value;
wherein the first module is configured to delay the second module from operating with the new value until a notification of a first event indicates acceptability for the second module to execute with the new value;
an event notification module coupled to the first module, wherein the first module is further configured to register, responsive to the request to change the current value of the first tunable, with the event notification module to receive notification of the first event associated with the first tunable;
a kernel subsystem handler coupled to the event notification module and configured to signal occurrence of the first event to the event notification module; and
wherein the event notification module is further configured to send an event notification to the first module in response to the notification of the first event, the first module is further configured to input the new value to the second module in response to receipt of the notification of the first event, and the second module executes with the new value responsive to input of the new value.

16. The system of claim 15, wherein the first module is further configured to transition the first tunable from a first state to a second state in response to the request to change the current value of the first tunable to the new value, responsive to a request for obtaining the value of the first tunable while in the second state and return the current tunable value, and responsive to notification of a first event and input of the new value transition the first tunable from the second state to the first state.

17. The system of claim 16, wherein the first module is further configured to, responsive to the signal indicating acceptability for the second module to execute with the new value, transition the first tunable from the second state to the first state and store the new tunable value as the current tunable value, responsive to a request for obtaining the value of the tunable received by the first module while the first tunable is in the first state, return the current tunable value, and responsive to notification of a first event and input of the new value transition the first tunable from the second state to the first state.

18. The method of claim 15, wherein the first module is further configured to transition the first tunable from a first state to a second state in response to the request to change the current value of the first tunable to the new value, responsive to receiving a second request to change the current value of the first tunable while the first tunable is in the second state return a code that indicates that requested change to the second new value was rejected, and responsive to notification of a first event and input of the new value transition the first tunable from the second state to the first state.

19. The method of claim 15, wherein the first module is further configured to transition the first tunable from a first state to a second state in response to the request to change the current value of the first tunable to the new value, and responsive to receiving a second request to change the current value to a second new value while the first tunable is in the second state, discard the first new value and use the second new value to update the current value, and responsive to notification of a first event and input of the second new value transition the first tunable from the second state to the first state.

20. The method of claim 15, wherein the first module is further configured to transition the first tunable from a first state to a second state in response to the request to change the current value of the first tunable to the new value, responsive receiving a cancel request for the first tunable while the first tunable is in the second state, discard the first new value and transition the first tunable to the first state.

21. An article of manufacture, comprising:
a processor-readable medium configured with instructions executable by one or more processors for updating a tunable used in an operating system kernel by performing the steps including,
receiving at a first module of the operating system a request to change a current value of a first tunable to a new value, wherein the value of the tunable affects execution of a second module of the operating system, and the new value is not equal to the current value;
registering, in response to the request to change the current value of the first tunable, the first module with an event notification module to receive notification of a first event associated with the first tunable;
delaying the second module from operating with the new value, and continuing to operate the second module with the current value until a notification of the first event indicates acceptability for the second module to execute with the new value;
receiving notification of the first event from a module of the operating system by the event notification module;
sending an event notification from the event notification module to the first module in response to the notification of the first event;
inputting the new value to the second module in response to receipt of the notification of the first event;
executing the second module with the new value; and
storing the new value for the first tunable in persistent storage.
